(19) United States
(12) Patent Application Publication
(10) Pub. No.: US 2008/0222689 A1
(43) Pub. Date: Sep. 11, 2008

(54) System to filter and multicast personal video content

(75) Inventors: Jerald Robert Howcroft, Beverly Hills, MI (US); Mari S. Quick, Boeme, TX (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/715,013

(22) Filed: Mar. 6, 2007

(51) Int. Cl. H04N 7/173

(52) U.S. Cl. 725/110

(57) ABSTRACT

In an embodiment, an Internet Protocol Television (IPTV) Set Top Box (STB) receives information regarding a personal channel on an IPTV system and information regarding a plurality of viewer IPTV STBs associated with the personal channel. The IPTV STB further receives personal video content, and filters the personal video content. The IPTV STB multicasts the filtered personal video content through a network to a plurality of viewer IPTV STBs.

### TECHNICAL FIELD

Various embodiments relate to multicasting personal video content, and in an embodiment, but not by way of limitation, to filtering personal video content before multicasting the personal video content.

### BACKGROUND

Current technology permits an individual to transmit over a network and/or post on a web site personal video content. One presently popular website for such posted content is www.youtube.com. Systems and methods have also been proposed to broadcast personal video content using broadcast television systems, cable television systems, and network-based television systems. However, all of these systems require continuous oversight by a central server or other centralized authority, and very little control and flexibility is afforded the publisher of the personal video content. The art would therefore benefit from a new approach to the broadcasting of personal video content over a network.

### BRIEF DESCRIPTION OF THE DRAWINGS

FIG. 1 illustrates an example embodiment of a system for the multicasting of personal video content over a network.

FIG. 2 illustrates an example embodiment of a process to multicast personal video content over a network.

FIG. 3 illustrates another example embodiment of a process to multicast personal video content over a network.

FIG. 4 illustrates an example embodiment of an electronic program guide in which a personal channel is listed.

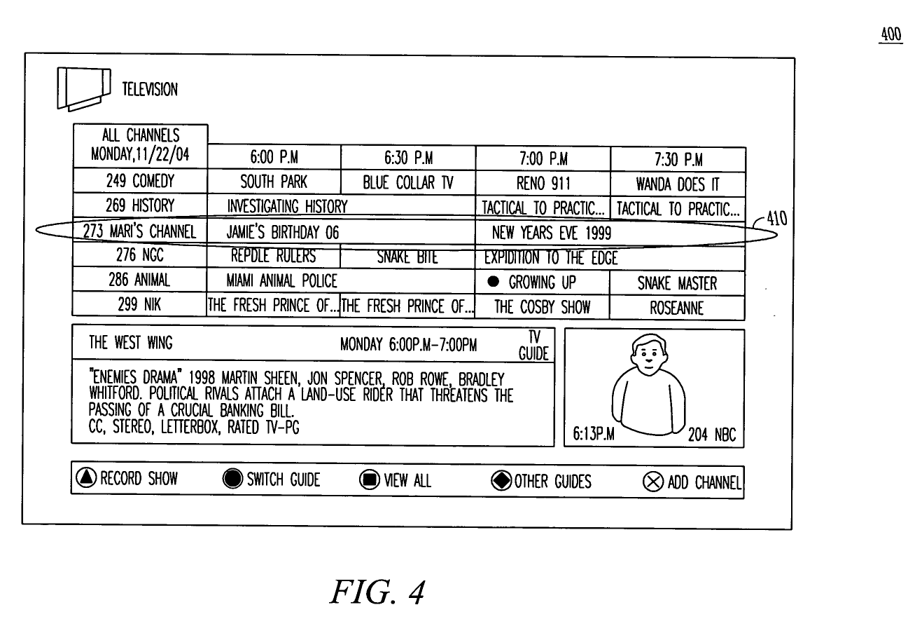

### DETAILED DESCRIPTION

In an embodiment, an Internet Protocol Television (IPTV) Set Top Box (STB) includes a configuration that permits it to receive information regarding a personal channel on an IPTV system and information regarding a plurality of viewer IPTV STBs associated with the personal channel. The configuration further permits the IPTV STB to receive personal video content, and to filter the personal video content. The IPTV STB further multicasts the filtered personal video content through a network directly to a plurality of viewer IPTV STBs.

In another embodiment, an Internet Protocol Television (IPTV) server includes a configuration to store in a memory information relating to a personal channel on an IPTV system and information relating to a plurality of viewer IPTV Set Top Boxes (STBs). The plurality of viewer IPTV STBs are to receive a multicast of personal video content directly from a publishing IPTV STB, and the personal video content is viewable on the personal channel. The IPTV server further transmits the information relating to the personal channel and the information relating to the plurality of viewer IPTV STBs to the publishing IPTV STB.

In another embodiment, a machine readable medium includes instructions for executing a process. As a first step, the process receives at a publishing Internet Protocol Television (IPTV) Set Top Box (STB) information regarding a personal channel on an IPTV system and information regarding a plurality of viewer IPTV STBs associated with the personal channel. The process then receives personal video content at the publishing IPTV STB and filters the personal video content at the publishing IPTV STB. The filtered personal video content is then multicasted from the publishing IPTV STB through a network directly to the plurality of viewer IPTV STBs.

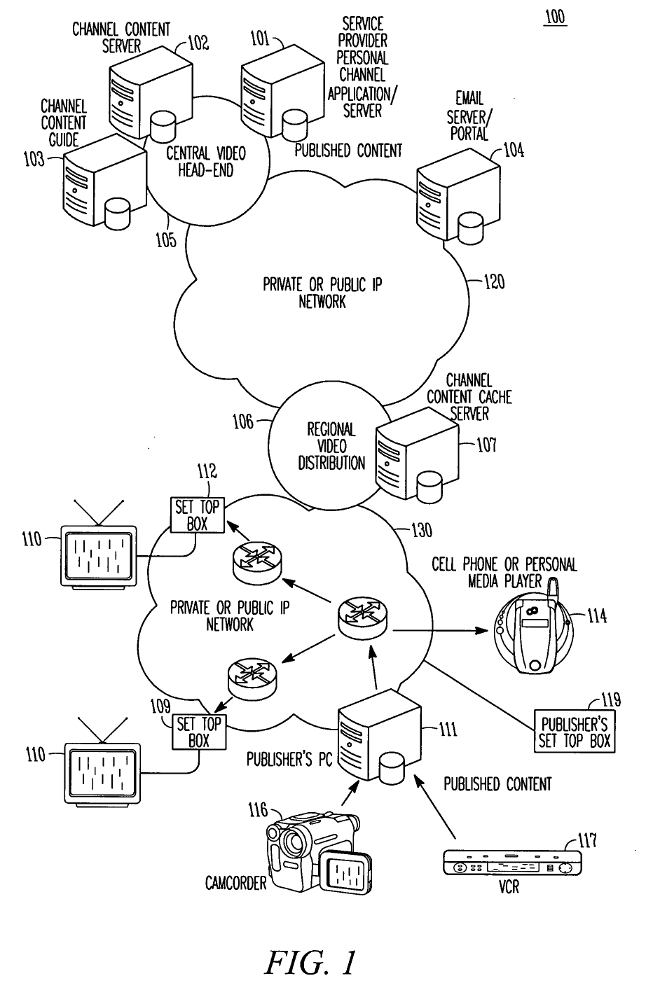

FIG. 1 illustrates an example embodiment of a system 100 for the multicasting of personal video content over a network. A central video head end 105 includes a service provider and personal channel application server 101, a channel content server 102, and a channel content guide 103. The central video head end 105 is coupled to an electronic mail server/portal 104 and a regional video distribution system 106 and server 107 through a public or private network 120. The regional video system 106 may be coupled to another private or public network 130.

A publisher's personal computer 111 and/or a publisher's IPTV STB 119 may be coupled to the network 130. A publisher refers to a person or other entity that supplies personal or other video content to the system 100. A cell phone and/or personal media player 114 may also be coupled to the network 130. A camcorder 116 and/or a video cassette recorder 117 may be coupled to the publisher's personal computer 111. A plurality of IPTV STBs 109, 112 and their associated IPTV display units 110 are coupled to the network 130. The IPTV STBs 109, 112 are able to view personal video content from the publisher IPTV STB 119 when the IPTV STBs 109, 112 subscribe to a particular personal channel associated with the publisher IPTV STB 119 or are associated in some other way with the publisher IPTV STB 119. Therefore, a personal channel is a channel over which a publisher's personal video content may be viewed by others. Any number of IPTV STBs 109, 112, and 119 may be coupled to the network 130, and any one of those STBs may publish personal video content on a personal channel and/or subscribe to a personal channel. Additionally, any one of those STBs may neither publish personal video content nor subscribe to a personal video channel (i.e., simply serve as a STB coupled to an IPTV system without access to any personal channels).

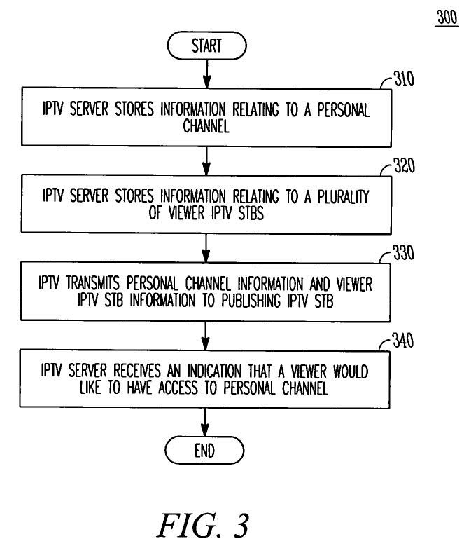

The system 100 of FIG. 1 provides a system in which an individual (i.e., the publisher) can provide personal video content to that individual's IPTV STB, and that personal video content is multicast to many other IPTV STBs to be viewed on a personal channel. The personal video channel service can be purchased by an IPTV subscriber (thereby becoming a publisher of personal video content) to provide personal video content to others. Such a publisher of personal video content can store and forward that content to an IPTV content server, or that publisher of personal video content can publish the personal video content directly from their STB and/or PC for downloading or streaming live video feed for near-real-time viewing to other IPTV viewers. The recipients or viewers of the personal video content may subscribe to a specific subscriber's video cast. Access to someone else's personal channel can be obtained using a STB user interface to manage and access subscriptions. In an alternative, an occasional channel can be set up by the IPTV service provider that would provide synchronous access to the personal video content. The occasional channel method would enable a TV viewer to simply tune to the channel assigned to the personal channel they subscribed to in order to access the personal video. The content would be streamed to their viewer STB for viewing once the personal channel is selected. The personal channel 310 can be listed as part of the standard electronic program guide 300 as illustrated in FIG. 3.

A customer portal can be used to enable customers to share their personal video content. A publisher may invite their friends and family to their published content for download or streaming and/or their personal channel by generating an email or other electronic message to the desired subscribers/viewers. The friends and family can use a link in the email to connect to the service provider portal to set up the personal channel and/or graphic user interface accessed personal video subscription. Alternatively, a publishing IPTV STB may enable unlimited access to its personal video content. The publisher can provide preview clips to potential subscribers.

Referring back to FIG. 1, in general, a person who wants to provide personal video content to other IPTV viewers uploads their content from a device such as a camcorder 116 to their PC 111 or STB 119 in a digital format that can be decoded and played on the device, such as MPEG4. The publisher may also upload their content to a service provider personal video application server 101. Any customer who would like to view the personal video content logs onto their service provider portal 104 to request the personal channel service. The portal interfaces with the channel content server 102 to add the personal channel to the publisher's channel map/channel lineup. The portal interfaces with the channel content guide server 103 to add the personal channel to the publisher's electronic programming guide. The personal channel content publisher interacts with the portal 104 to identify who they would like to make their content available to and may choose to enter email addresses to allow access to the content. The publisher can send an email to the people they have identified as being allowed to view their content.

A personal channel that carries personal video content of a subscriber-publisher, by its very nature, restricts the viewing of that personal content for privacy, parental control, and/or other reasons. This restriction results from the fact that a publisher can control to whom subscription and access are provided. For example, for content that is being restricted to specified email addresses, the viewer may be sent an email from the portal email server 104 inviting them to access the personal channel being published. The email will contain instructions regarding how to opt in to the personal channel. As another example, any type of service provider account ID, such as a single sign-on, can manage personalization across platforms. For non-restricted personal channels, the viewer can find the channels on their service provider portal 104 and request access to a personal channel. The portal interfaces with the channel content server 102 to add the personal channel to the viewer's channel map/channel lineup. The portal interfaces with the channel content guide server 103 to add the personal channel to the viewer's electronic programming guide.

The viewer accesses the electronic programming guide on their viewer IPTV STB (109, 112) and selects a personal channel that they have subscribed to in order to view the personal video content. The content is streamed to the viewers IPTV STB (109, 112) from its current location (101 or 119). If the content is published in the service provider personal video application server, it will travel through the central video head end office (105) to the regional video distribution office (106) and on to the viewers STB (109, 112). Popular personal channels may have their content cached in a channel content cache server (107).

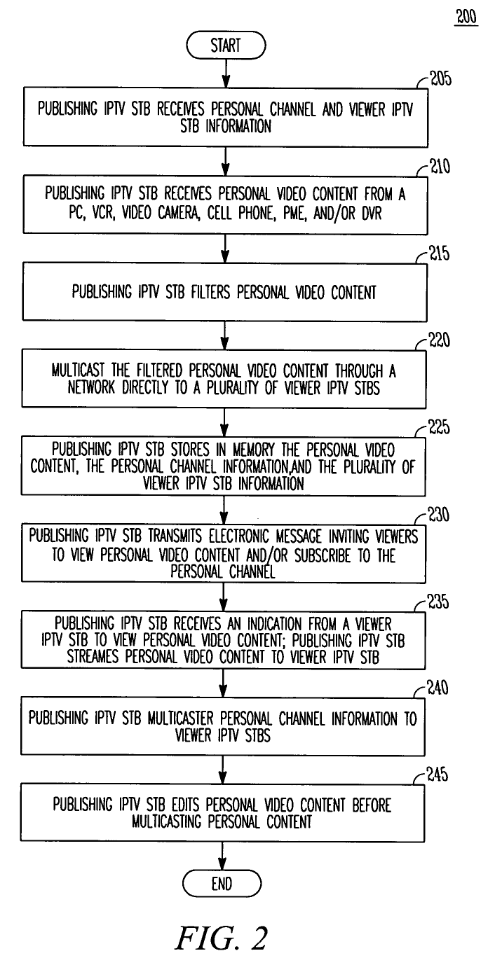

FIG. 2 illustrates an example embodiment of a process 200 to supply personal video content from a publisher IPTV STB to a plurality of viewer IPTV STBs. At 205, a publishing IPTV STB receives information regarding a personal channel on an IPTV system and information regarding a plurality of viewer IPTV STBs associated with the personal channel. At 210, the publishing IPTV STB receives personal video content from one or more of a personal computer, a video cassette recorder, a video camera, a camcorder, a cell phone, a personal media player, and/or a digital video recorder. At 215, the publisher IPTV STB, or a device associated with the IPTV STB, filters the personal video content. This filtering can be based on a variety of criteria. For example, if the personal video content depicts the preparations for a surprise party, the publisher IPTV STB may want to prevent the person for whom the party is being given from accessing this personal video content on the personal channel. At 220, the publisher IPTV STB multicasts the filtered personal video content through a network directly to a plurality of viewer IPTV STBs. The multicasting of the personal video content may be executed by the publishing IPTV STB substantially immediately to the plurality of viewer IPTV STBs upon receiving the personal video content at the publishing IPTV STB, thereby generating a substantially real time transmission of the personal video content to the plurality of viewer IPTV STBs.

At 225, the publishing IPTV STB stores in a memory associated with the publishing IPTV STB the personal video content, the information regarding a personal channel, and the information regarding a plurality of viewer IPTV STBs. At 230, the publishing IPTV STB sends an electronic message to a plurality of viewer IPTV STBs. The electronic message may include an offer to subscribe to the personal channel and to invite the plurality of IPTV STBs to view the personal video content on the personal channel. At 235, the publishing IPTV STB receives an indication from a viewer IPTV STB that that viewer IPTV STB has selected the personal channel, and at 240 the publishing IPTV STB streams the personal video content to the viewer IPTV STB. In the streaming process, the publishing IPTV STB may identify within the multicast personal video content the personal channel upon which the plurality of viewer IPTV STBs can access the personal video content. At 245, the publisher IPTV STB permits the personal video content to be edited before it is multicast to the viewer IPTV STBs.

FIG. 3 illustrates an example embodiment of a process 300 that may be used in connection with the process 200 of FIG. 2. In process 300, at 310, an Internet Protocol Television (IPTV) server stores in a memory information relating to a personal channel on an IPTV system. At 320, the IPTV server stores in the memory information relating to a plurality of viewer IPTV Set Top Boxes (STB). The plurality of viewer IPTV STBs can receive a multicast of personal video content directly from a publishing IPTV STB, and the personal video content is viewable on the personal channel. At 330, IPTV server transmits the information relating to the personal channel and the information relating to the plurality of viewer IPTV STBs to the publishing IPTV STB. At 340, the IPTV server receives from the publishing IPTV STB and/or a viewer IPTV STBs an indication that a viewer would like to have access to the personal channel associated with the publisher IPTV STB.

In the foregoing detailed description, various features are grouped together in one or more examples or examples for the purpose of streamlining the disclosure. This method of disclosure is not to be interpreted as reflecting an intention that the claimed examples of the invention require more features than are expressly recited in each claim. Rather, as the following claims reflect, inventive subject matter lies in less than all features of a single disclosed example. Thus the following claims are hereby incorporated into the detailed description as examples of the invention, with each claim standing on its own as a separate example. It is understood that the above description is intended to be illustrative, and not restrictive. It is intended to cover all alternatives, modifications and equivalents as may be included within the scope of the invention as defined in the appended claims. Many other examples will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. An Internet Protocol Television (IPTV) Set Top Box (STB) comprising a configuration to:
receive information regarding a personal channel on an IPTV system;
receive information regarding a plurality of viewer IPTV STBs associated with the personal channel;
receive personal video content;
filter the personal video content; and
multicast the filtered personal video content through a network to the plurality of viewer IPTV STBs.

2. The IPTV STB of claim 1, wherein the network comprises an IPTV network.

3. The IPTV STB of claim 1, further comprising a configuration to substantially immediately multicast the personal video content to the plurality of viewer IPTV STBs upon receiving the personal video content, thereby generating a substantially real time transmission of the personal video content to the plurality of viewer IPTV STBs.

4. The IPTV STB of claim 1, further comprising a memory to store one or more of the personal video content, the information regarding a personal channel, and the information regarding the plurality of viewer IPTV STBs.

5. The IPTV STB of claim 1, further comprising a configuration to send an electronic message to the plurality of viewer IPTV STBs, the electronic message comprising one or more of a message to offer a subscription to the personal channel and to invite the plurality of viewer IPTV STBs to view the personal video content on the personal channel.

6. The IPTV STB of claim 5, further comprising a configuration to receive an indication from a particular viewer IPTV STB that the particular viewer IPTV STB has selected the personal channel, and to stream the personal video content to the particular viewer IPTV STB.

7. The IPTV STB of claim 1, further comprising a configuration to identify within the multicast personal video content the personal channel upon which the plurality of viewer IPTV STBs can access the personal video content.

8. The IPTV STB of claim 1, further comprising a configuration to edit the personal video content before the personal video content is multicast to the plurality of viewer IPTV STBs.

9. The IPTV STB of claim 1, further comprising a configuration to receive the personal video content from one or more of a personal computer, a video cassette recorder, a video camera, a cell phone, a personal media player, and a digital video recorder.

10. An Internet Protocol Television (IPTV) server comprising a configuration to:
store in a memory information relating to a personal channel on an IPTV system;
store in the memory information relating to a plurality of viewer IPTV Set Top Boxes (STB) that are to receive a multicast of personal video content from a publisher IPTV STB that filters the personal video content, the personal video content viewable on the personal channel; and
transmit the information relating to the personal channel and the information relating to the plurality of viewer IPTV STBs to the publisher IPTV STB.

11. The IPTV server of claim 10, further comprising a configuration to receive from the publisher IPTV STB and one or more of the viewer IPTV STBs an indication that a viewer would like to have access to the personal channel associated with the publisher IPTV STB.

12. A machine readable medium comprising instructions for executing a process comprising:
receiving, at a publisher Internet Protocol Television (IPTV) Set Top Box (STB), information regarding a personal channel on an IPTV system and information regarding a plurality of viewer IPTV STBs associated with the personal channel;
receiving personal video content at the publisher IPTV STB;
filtering the personal video content at the publisher IPTV STB; and
multicasting the filtered personal video content from the publisher IPTV STB through a network to the plurality of viewer IPTV STBs.

13. The machine readable medium of claim 12, wherein the network comprises an IPTV network.

14. The machine readable medium of claim 12, further comprising instructions to substantially immediately multicast the personal video content from the publisher IPTV STB to the plurality of viewer IPTV STBs upon receiving the personal video content at the publisher IPTV STB, thereby generating a substantially real time transmission of the personal video content from the publisher IPTV STB to the plurality of viewer IPTV STBs.

15. The machine readable medium of claim 12, further comprising instructions to store in a memory associated with the publisher IPTV STB one or more of the personal video content, the information regarding a personal channel, and the information regarding the plurality of viewer IPTV STBs.

16. The machine readable medium of claim 12, further comprising instructions to send an electronic message from the publisher IPTV STB to the plurality of viewer IPTV STBs, the electronic message comprising one or more of a message to subscribe to the personal channel associated with the personal video content and to invite the plurality of IPTV STBs to view the personal video content on the personal channel.

17. The machine readable medium of claim 16, further comprising instructions to receive an indication at the publisher IPTV STB from a viewer IPTV STB that that viewer IPTV STB has selected the personal channel, and further comprising instructions to stream the personal video content from the publisher IPTV STB directly to the viewer IPTV STB.

18. The machine readable medium of claim 12, further comprising instructions for the publisher IPTV STB to identify within the multicast of personal video content the personal channel on which the plurality of viewer IPTV STBs can access the personal video content.

19. The machine readable medium of claim 12, further comprising instructions associated with the publisher IPTV STB to edit the personal video content before the personal video content is multicast from the publisher ITPV STB to the plurality of viewer IPTV STBs.

20. The machine readable medium of claim 12, further comprising instructions to receive the personal video content at the publisher IPTV STB from one or more of a personal computer, a video cassette recorder, a video camera, a cell phone, a personal media player, and a digital video recorder.
